(19) United States
(12) Patent Application Publication
(10) Pub. No.: US 2010/0146795 A1
(43) Pub. Date: Jun. 17, 2010

(54) Serrated Pipe Cutter and Serrated Blade Therefor

(76) Inventor: Joseph J. Houle, East Hampton, MA (US)

Correspondence Address: MCCARTER & ENGLISH, LLP HARTFORD;CITYPLACE I, 185 ASYLUM STREET, HARTFORD, CT, 06103, US

(21) Appl. No.: 12/336,408

(22) Filed: Dec. 16, 2008

(51) Int. Cl. B23D 21/10; B26B 13/08

(52) U.S. Cl. 30/134; 30/92; 30/250; 30/123; 30/355

(57) ABSTRACT

A serrated pipe cutter comprising handles pivotally coupled together and movable between first and second positions; wherein the first handle includes a grip at one end and a blade at an opposite end; the blade includes an elongated cutting edge which defines a cutting edge surface tapering inwardly, a plurality of serrations extending along the cutting edge, and a plurality of cutting tips extending between adjacent serrations. Each serration defines a cutting edge surface, a substantially concave facet tapering inwardly, and a linear serration cutting edge extending between adjacent cutting tips. Each cutting tip defines a cutting tip surface tapering inwardly and a linear cutting tip edge extending between adjacent serrations, at least a portion of which is offset from at least a portion of the serration cutting edge.

### FIELD OF THE INVENTION

The present invention relates to cutting tools and, more particularly, to serrated pipe cutters having a pair of pivoted handles, one of which carries a serrated blade and the other of which supports the article to be cut.

### BACKGROUND OF THE INVENTION

Cutting tools, particularly handled serrated pipe cutters, have many uses. Conduits and other tubular articles, such as pipes, are often manufactured in bulk and handled cutting tools are often employed to cut the bulk length of manufactured conduit into smaller lengths.

Known types of handled cutting tools include pipe cutters which carry a straight blade. One drawback associated with cutters of this type is that, when placed in initial contact with an article to be cut, the force applied to the cutting tool is spread along the entire edge of the straight blade, thereby reducing the pressure applied on the article; as such, an increased force is required to initiate the cut into the article. Not only is this increased force burdensome for the user, it presents a further drawback of potentially resulting in deformation of the article in the area surrounding the applied force.

Other types of cutting tools include handled cutting tools which carry a blade that is of a constant thickness. One drawback associated with cutting tools of this variety is that, as the blade passes through the article, its lateral sides remain in constant contact with the interior material of the article. A frictional force thereby is applied to the blade from the article, requiring an increased force to be applied during execution of the cut.

Other types of known pipe cutters include blades with a jagged edge, or saw tooth, blade. This type of blade cuts in a lateral motion, by pushing and pulling the blade through the article to be cut in a direction perpendicular to the longitudinal axis of the article. One drawback associated with cutting tools of this kind is that they do not include a support system for the article, thereby requiring the user to support the article separately in a cumbersome fashion as the cut is made. Another drawback associated with cutting tools of this nature is that they can only be used in an area that provides sufficient space for the user to effect the lateral-motion cut.

Accordingly, it is an object of the present invention to overcome one or more of the above-described drawbacks and/or disadvantages of the prior art.

### SUMMARY OF THE INVENTION

In accordance with a first aspect, the present invention is directed to a serrated pipe cutter comprising first and second handles that are coupled together and movable relative to each other. The first or upper handle includes a jaw for engaging one side of the pipe to be cut, and the second or lower handle includes a serrated blade for engaging the opposite side of the pipe relative to the jaw and for cutting the pipe against the jaw. The serrated blade defines a back edge and an elongated cutting edge located on an opposite side of the blade relative to the back edge. The blade further comprises a first side edge extending between the back and cutting edges of the blade, a second side edge located on an opposite side of the blade relative to the first side edge, and a blade body extending between the first, second, back and cutting edges of the blade. The blade further includes faceted surfaces located on opposite sides of the blade relative to each other and tapering inwardly in a direction from the body toward the cutting edge of the blade. The elongated cutting edge defines along one side thereof a plurality of serrations that are axially spaced relative to each other along the cutting edge. The opposite side of the cutting edge relative to the serrations is substantially planar, and defines a plurality of axially spaced, relatively shallow recesses at the cutting edge, wherein each recess is defined by a respective serration formed on the opposite side of the blade. Each serration defines a curvilinear serration boundary between the respective serration and a contiguous faceted surface, a substantially concave serration surface located within the curvilinear serration boundary and tapering inwardly in a direction from the body toward the cutting edge, and an axially-extending serration cutting edge.

The elongated cutting edge of the blade further defines a plurality of cutting tips extending between adjacent serrations. Each cutting tip defines an axially extending cutting tip edge, and each serration cutting edge is recessed inwardly on the elongated cutting edge relative to at least one contiguous cutting tip edge. The second or upper handle includes on the distal end thereof a jaw defining a substantially concave recess for receiving therein the pipe to be cut. At least one of the first and second handles is movable relative to the other to engage the pipe with the elongated cutting edge of the blade and cut the pipe.

In some embodiments, the serrated cutting edge defines a plurality of substantially linear cutting edge surfaces, wherein at least one linear cutting edge surface is angled inwardly toward the body at an acute angle within the range of about 8° to about 12°. In one such embodiment, each of the serrated cutting edges defines two substantially linear cutting edge surfaces located on opposite sides of the serrated cutting edge relative to each other and angled inwardly toward the body, and at least one substantially linear cutting edge extending between the two angled cutting edges.

In some embodiments, the serration boundaries each define an apex and a pair of substantially symmetrical, curvilinear boundary lines, each extending on opposite sides of the apex relative to each other between the apex and a respective contiguous cutting tip. In one such embodiment, each serration boundary is substantially elliptical shaped.

In some embodiments, the serrations are substantially equally spaced relative to each other along the elongated cutting edge. In one such embodiment, the distance between each serration apex and contiguous cutting tip edge is within the range of about 3/100 inch to about 9/100 inch. In another embodiment, at least a portion of each serration edge is substantially curvilinear and/or substantially straight.

In some embodiments, the cutting tips each define a substantially straight axially extending cutting tip edge and a pair of faceted surfaces on opposite sides of the cutting tip relative to each other and tapering inwardly toward the axially extending cutting tip edge. In one such embodiment, the faceted surfaces of each cutting tip taper inwardly relative to the respective side of the blade body at an angle within the range of about 20° to about 30°.

In some embodiments, the serration cutting edges each define an axial length within the range of about 4/100 inch and about 9/100 inch, and a plurality of the cutting tip edges each define an axial length within the range of about 3/100 inch and about 8/100 inch. In some embodiments, each substantially concave serration surface is defined by a radius within the range of about 2 inches to about 4 inches.

In some embodiments, a plurality of the cutting tips each define a first substantially linear cutting tip boundary between the respective cutting tip and a contiguous faceted surface, a second substantially linear cutting tip boundary between the cutting tip and an adjacent serration, and a third substantially linear cutting tip boundary between the cutting tip and an adjacent serration opposite the second cutting tip boundary Faceted surfaces are formed on opposites sides of the cutting tip relative to each other, and on the serrated side of the blade, the faceted surfaces are formed within the first and second boundaries and taper inwardly in the direction from the body toward the cutting edge. In one embodiment, at least a portion of each cutting tip edge is substantially curvilinear and/or substantially straight.

In some embodiments, the pipe cutter further comprises a locking mechanism releasably engageable with the handles. The locking mechanism defines an open state, wherein the locking mechanism is disengaged from the handles and allows movement of the handles relative to one another between an open position and a closed position, and a locked state, wherein the locking mechanism engages at least one of the handles to prevent movement of the handles relative to one another.

In accordance with another aspect, the present invention is directed to a serrated pipe cutter comprising first means for manually gripping and second means mounted on the first means for cutting a pipe. The second means defines an axially elongated cutting edge including a plurality of third means for serrating the cutting edge that are axially spaced relative to each other along the cutting edge. The second means also defines a plurality of fourth means for forming non-serrated cutting edge segments that are axially spaced relative to each other along the cutting edge. Each of a plurality of fourth means are located between respective third means, and the third means are recessed inwardly on the elongated cutting edge relative to adjacent fourth means. The pipe cutter further comprises fifth means coupled to the first means for supporting the pipe and for manually gripping. At least one of the first and fifth means is manually movable relative to the other for driving the elongated cutting edge of the second means into engagement with the pipe to cut the pipe.

In one embodiment, the first means is a first handle, the second means is a blade, each third means is a serration axially spaced relative to an adjacent serration, and each fourth means is a cutting tip defining a substantially linear cutting edge segment and a pair of faceted surfaces formed on opposite sides of the cutting tip relative to each other. Each serration defines a boundary having an apex and curvilinear boundary lines extending substantially symmetrically between the apex and the cutting edge, a substantially concave serration surface formed within the boundary, and a serration cutting edge. Each pair of faceted surfaces tapers inwardly toward the respective linear cutting edge, and each serration cutting edge is recessed inwardly relative to at least one contiguous linear cutting edge segment.

In one embodiment, the pipe cutter further comprises sixth means coupled to at least one of the first means and fifth means for releasably engaging the first means and/or the fifth means and preventing relative movement of the first means and fifth means. In one embodiment, the sixth means is a locking mechanism that defines a locked state wherein the locking mechanism engages at least one of the first and second handles to prevent movement of the first handle relative to the second handle, and an open state wherein the locking mechanism disengages at least one of the first and second handles to allow movement of the first handle relative to the second handle between an open position and a closed position.

In accordance with another aspect, the present invention is directed to a serrated blade defining an elongated serrated cutting edge and mountable within a serrated pipe cutter including a first handle, a second handle coupled to the first handle, and including a jaw defining a substantially concave recess for receiving therein a pipe to be cut. The first and/or second handle is movable relative to the other to engage a pipe with the elongated cutting edge of the blade and cut the pipe. The serrated blade defines a back edge, an elongated cutting edge located on an opposite side of the blade relative to the back edge, a first side edge extending between the back and cutting edges of the blade, a second side edge located on an opposite side of the blade relative to the first side edge, a blade body extending between the first, second, back and cutting edges of the blade, and faceted surfaces located on opposite sides of the blade relative to each other and tapering inwardly in a direction from the body toward the cutting edge of the blade. The elongated cutting edge defines a plurality of serrations axially spaced relative to each other along one side of the blade, and a substantially planar surface located on an opposite side of the cutting edge relative to the serrations. Each serration defines a curvilinear serration boundary between the respective serration and a contiguous faceted surface, a substantially concave serration surface located within the curvilinear serration boundary and tapering inwardly in a direction from the body toward the cutting edge, and an axially-extending serration cutting edge. The elongated cutting edge of the blade further defines a plurality of cutting tips extending between adjacent serrations. Each cutting tip defines an axially extending cutting tip edge, and each serration cutting edge is recessed inwardly on the elongated cutting edge relative to at least one contiguous cutting tip edge.

One advantage of the present invention is that the serrations along the cutting edge improve cutting performance by providing additional cutting points and by effectively increasing the length of the cutting edge in comparison to straight edge blades. Further, the serrations improve cutting edge wear, as the additional cutting points initiate the cut, which effectively reduces the amount of force applied to the sharpened recessed curves that continue the cut.

Another advantage of the currently preferred embodiments of the present invention is that the substantially concave recess of the jaw supports the pipe, allowing for easier execution of the cut. Another advantage of the currently preferred embodiment of the present invention is that the slot formed within the jaw receives at least a portion of the blade in the second position, thereby ensuring that a clean cut is made through the pipe. Yet another advantage of the currently preferred embodiments of the present invention is that, as the cut is made via a downwardly applied force, and not by a sawing action, the tool may be used in a tight or narrow space. Another advantage of the currently preferred embodiments of the present invention is that the locking mechanism is engageable to ensure that the two handles remain closed when desired, providing easy mobility and safe storage of the pipe cutter.

Other advantages of the present invention, and/or of the currently preferred embodiments thereof, will become more readily apparent in view of the following detailed description of the currently preferred embodiments and accompanying drawings.

### BRIEF DESCRIPTION OF THE DRAWINGS

FIG. 1 is a perspective view of one embodiment of a serrated pipe cutter of the present invention.

FIG. 2A is a side elevational view of the serrated side of the blade of the serrated pipe cutter of FIG. 1, and FIG. 2B is a partial, enlarged, side elevational view of the non-serrated side of the blade of FIG. 2A.

FIG. 3 is a partial, enlarged, side elevational view of the serrations of the blade of the serrated pipe cutter of FIG. 1.

FIG. 4A is a cross sectional view of the blade of the serrated pipe cutter of FIG. 1 taken along line 4-4 of FIG. 2A.

FIG. 4B is a cross-sectional view of the tip of the blade of the serrated pipe cutter of FIG. 1 at detail 4B of FIG. 4A.

FIG. 5A is a cross-sectional view of the blade of the serrated pipe cutter of FIG. 1 taken along line 5-5 of FIG. 2A.

FIG. 5B is a cross-sectional view of the tip of the blade of the serrated pipe cutter of FIG. 1 at the detail 5B of FIG. 5A.

FIG. 6 is a partial, enlarged, side elevational view of one of the handles of the serrated pipe cutter of FIG. 1 illustrating the recess on the handle for receiving the locking mechanism.

FIG. 7A is a side elevational view of the locking member of the locking mechanism of the serrated pipe cutter of FIG. 1.

FIG. 7B is an end elevational view of the locking member of the locking mechanism of the serrated pipe cutter of FIG. 1.

### DETAILED DESCRIPTION OF THE CURRENTLY PREFERRED EMBODIMENTS

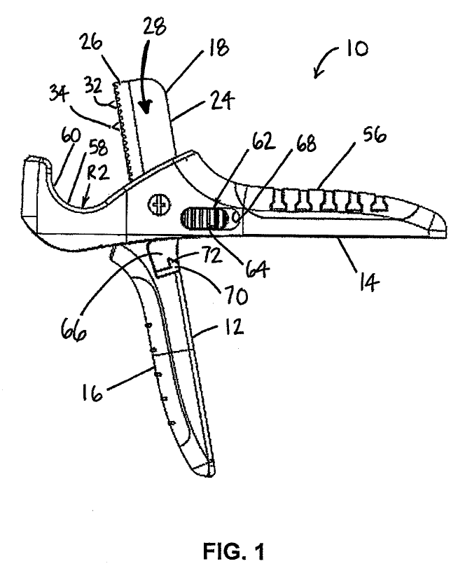

As illustrated in FIG. 1, a serrated pipe cutter embodying the present invention is indicated generally by the reference numeral 10. The pipe cutter 10 comprises a pair of handles 12 and 14. The handles 12 and 14 are pivotally connected and movable between first and second positions. In the currently preferred embodiment, the cutting tool 10 is a serrated pipe cutter for cutting pipes. The term pipe herein is used to mean any pipe, conduit, duct, hose, tube, or other like hollow or solid article, made in any shape and of any material that is known or becomes known.

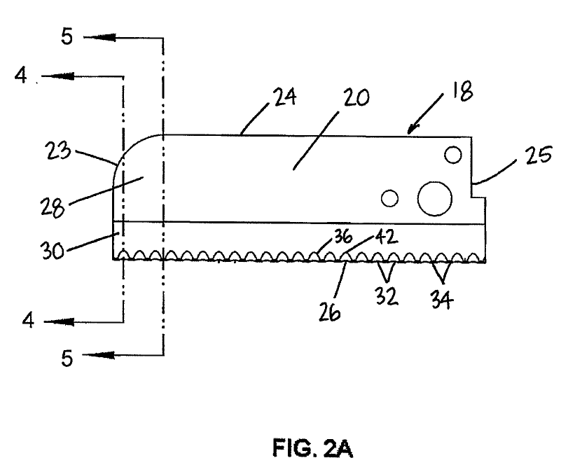

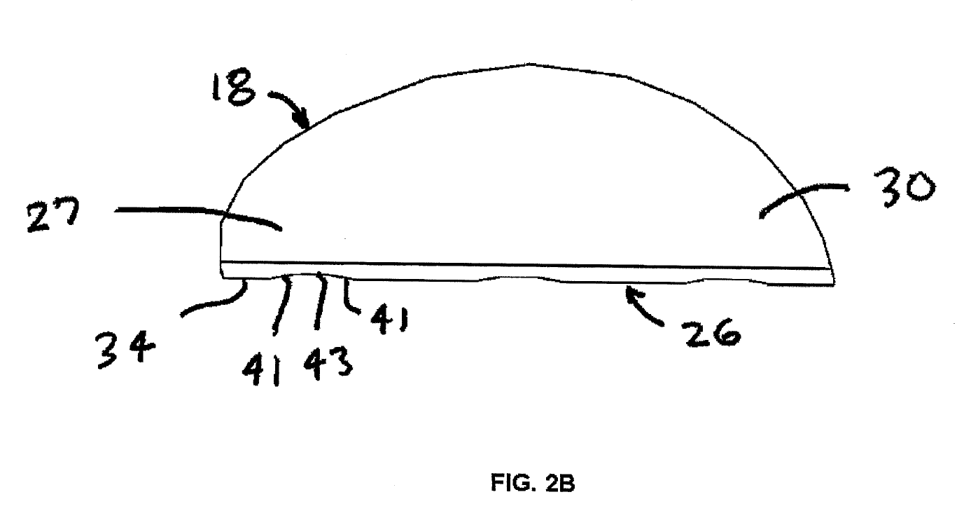

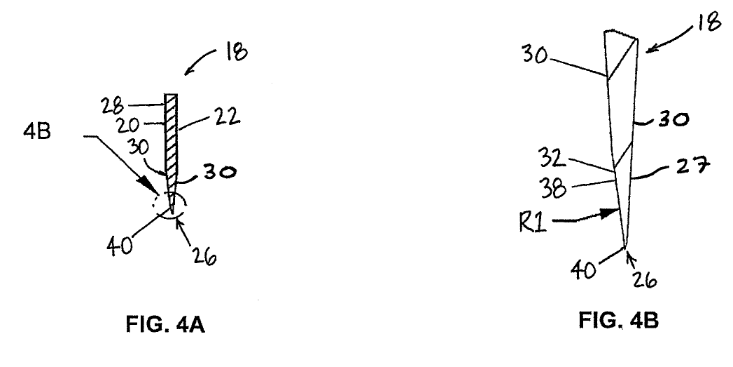

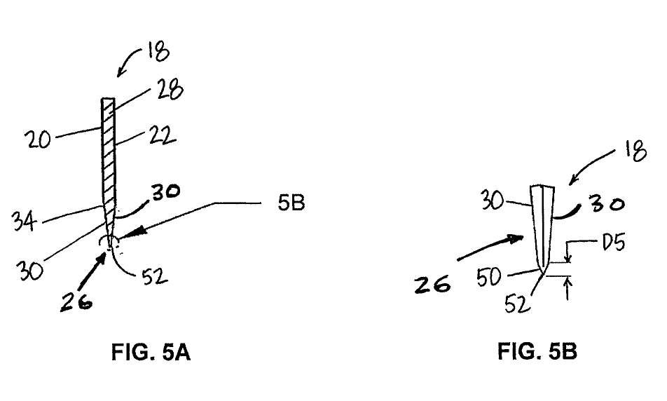

As shown in FIGS. 1-3, the handle 12 includes a grip 16 at one end and a blade 18 at the opposite end. As illustrated in FIGS. 4A and 5A, the blade 18 includes a first side 20 and a second side 22. As shown in FIGS. 1 and 2, the blade 18 further includes a back edge 24 and a cutting edge 26 located on an opposite side of the blade from the back edge 24. The blade 18 also includes a body 28 extending between the back, first, second and cutting edges of the blade and, as shown in FIGS. 4A and 5A, the body defines a first side 20 and a second opposite side 22. Preferably, the thickness of the body 28 is within the range of about 5/100 inch to about 7/100 inch, and more preferably about 6/100 inch. As may be recognized by those of ordinary skill in the pertinent art based on the teachings herein, these dimensions of the blade are only exemplary and may take any dimension that is known or becomes known.

Making reference to FIGS. 2A-B and 4A-B, the blade 18 defines a pair of cutting edge surfaces or facets 30 formed on opposite sides of the body 28 relative to each other at the cutting edge 26, and tapering inwardly in the direction from the body 28 toward the cutting edge. The taper of each facet 30 relative to the respective side is within the range of about 8 degrees to about 12 degrees, and most preferably is about 10 degrees. As may be recognized by those of ordinary skill in the pertinent art based on the teachings herein, these angles are only exemplary and the taper(s) may take any angle that is known or becomes known. Further, the cutting edge 26 can be made of any material that is known or that becomes known to those skilled in the pertinent art, and can be made of a material different from that of the body 28. In the instance of a bi-metal blade, for example, the cutting edge 26 can be joined to the body 28 by any method that is known or that later becomes known to those skilled in the pertinent art.

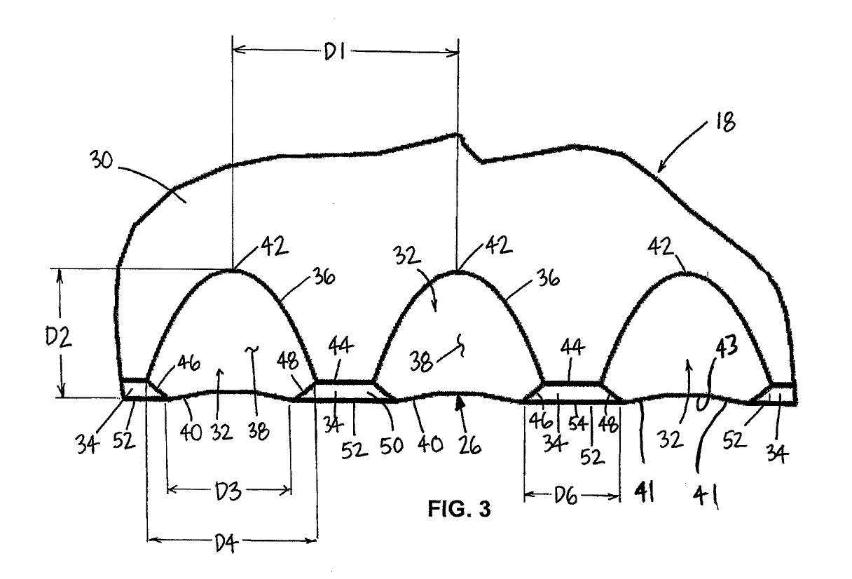

As shown best in FIGS. 2A-B and 3, the cutting edge 26 includes a plurality of serrations 32 axially spaced relative to the other along one side of the cutting edge (FIG. 2A), and a plurality of cutting tips 34 located between the serrations. As shown typically in FIGS. 2B and 4B, the opposite side 27 of the blade relative to the serrations 32 is substantially planar; however, the substantially planar side of the cutting edge 26 defines a plurality of axially-spaced recesses thereon defined by the serrations 32 formed on the opposite side of the cutting edge. As shown best in FIG. 3, in the illustrated embodiment, each serration 32 extends between two cutting tips 34. However, not all serrations 32 may have contiguous cutting tips 34. For example, serrations at the ends or corners of the blade may not have contiguous cutting tips, or some serrations may be contiguous without cutting tips therebetween. Each serration 32 is defined by a curvilinear serration boundary 36, defining a boundary between the respective serration 32 and the cutting edge surface 30, and a substantially concave facet 38 located within the serration boundary 36 which tapers inwardly in the direction from the body 28 towards the cutting edge 26. As shown typically in FIG. 4B, the concavity of each serrated facet 38 is defined by a radius R1. In a currently preferred embodiment of the present invention, the radius R1 is within the range of abut 2 inches to about 4 inches. However, as may be recognized by those of ordinary skill in the pertinent art based on the teachings herein, these dimensions are only exemplary and may take any dimension that is known or becomes known.

As shown best in FIG. 3, each serration 32 includes a linear serration cutting edge 40 which extends between the two adjacent cutting tips 34. In the illustrated embodiment, each serration cutting edge 40 is defined by a plurality of rectilinear segments. As shown typically in FIG. 3, each serration cutting edge 40 defines two rectilinear segments 41 that angle inwardly toward the body of the blade at opposite ends of the serration cutting edge relative to each other, and a third rectilinear segment 43 extending between the angled rectilinear segments 41. The angled rectilinear segments 41 are oriented at acute angles relative to the back edge 24 of the blade, and the third rectilinear segment 43 is substantially parallel to the back edge 24 of the blade. However, as may be recognized by those of ordinary skill in the pertinent art based on the teachings herein, each serration cutting edge 40 may take any of numerous different shapes and configurations that are currently known or that later become known. For example, each serration cutting edge 40 may be substantially curvilinear, or each serration cutting edge may include at least a portion which is substantially curvilinear and/or a portion which is substantially straight.

As shown in FIG. 3, each curvilinear serration boundary 36 defines a serration apex 42 and a substantially elliptical-shaped boundary line 36 that extends symmetrically between the respective apex and the cutting edge. In the illustrated embodiment, the axial distance D1 between apexes of adjacent serrations is within the range of about 8/100 inch to about 15/100 inch, and is preferably about ⅛ inch. Also in the illustrated embodiment, the distance D2 between each serration apex 42 and the respective cutting tip edges 52 (hereinafter described) is within the range of about 3/100 inch to about 9/100 inch. As may be recognized by those of ordinary skill in the pertinent art based on the teachings herein, these angles and dimensions are only exemplary and may take any of numerous different dimensions and/or angles that are known or become known. In addition, the distances D1 and/or D2 may vary from one serration to another.

As illustrated in FIGS. 3, 5A and 5B, the cutting edge 26 further includes a plurality of cutting tips 34 located between and/or adjacent to the serrations 32. Each cutting tip 34 defines a first linear cutting tip boundary 44 between the respective cutting tip 34 and the cutting edge surface 30, and second and third linear cutting tip boundaries 46 and 48, respectively, located between the respective cutting tip 34 and adjacent serration(s) 32.

Each serration cutting edge 40 intersects at one end thereof the respective second linear boundary 46 and intersects at the other end thereof the respective third linear boundary 48. In the illustrated embodiment, the linear distance D3 between the two intersection points is preferably within the range of about 4/100 inch to about 9/100 inch. As can be seen, the serration boundary 36 also intersects the adjacent second linear boundary 46 and third linear boundary 48. In the illustrated embodiment, the linear distance D4 between the two intersection points is preferably within the range of about 6/100 inch to about 12/100 inch. Each cutting tip 34 also includes a pair of cutting tip surfaces 50 located on opposite sides of the body 28 relative to each other, which taper inwardly toward the cutting edge 26. In the illustrated embodiment, each cutting surface 50 is substantially planar. In the currently preferred embodiment, each cutting surface 50 tapers inwardly relative to the first side 20 of the blade 18 at an angle within the range of about 24 degrees to about 26 degrees, and preferably about 25 degrees. However, as may be recognized by those of ordinary skill in the pertinent art based on the teachings herein, these dimensions and angles are only exemplary and the cutting surface 50 may take any dimension or shape that is known or becomes known. For example, the cutting surfaces 50 may be substantially concave.

Each cutting tip 34 defines a linear cutting tip edge 52 extending between adjacent serrations 32. In the illustrated embodiment, each linear cutting tip edge 52 is substantially straight. However, as may be recognized by those of ordinary skill in the pertinent art based on the teachings herein, the cutting tip edges 52 may take any of numerous different shapes and configurations that are currently known or that later become known. For example, each cutting tip edge 52 may be substantially curvilinear or may include at least a portion which is substantially curvilinear and/or a portion which is substantially straight.

In the currently preferred embodiment, and as shown typically in FIG. 5B, the distance D5 from the first linear cutting edge boundary to the cutting tip edge is about 1/100 inch. Also in the currently preferred embodiment, and as shown best in FIG. 3, each serration cutting edge 40 is recessed inwardly at the cutting edge 26 relative to the adjacent cutting tip edge 52 such that at least a portion of the cutting tip edge 52 makes initial contact with the pipe to be cut prior to the cutting edge 40 making initial contact with the pipe. One advantage of the currently preferred embodiment is that the cutting tip edge 52 comes into contact with the pipe first, which effectively reduces the amount of pressure applied to the blade 18 and eases the initiation of the cut. The cutting tip edge 52 intersects the second linear boundary 46, as well as the third linear boundary 48. In the illustrated embodiment, the linear distance D6 between the two intersection points is preferably within the range of about 3/100 inch to about 8/100 inch.

The body 28 of the blade 18 preferably defines a thickness within the range of about 50/1000 of an inch to about 120/1000 of an inch, and in the illustrated embodiment is about 62/1000 of an inch. One advantage of forming the serrations on only one side of the blade is that it avoids forming an overly thin section at the cutting edge 26 that otherwise might give rise to premature chipping or breakage of the blade. Yet another advantage of the currently preferred embodiment is that the non-serrated side of the blade nevertheless defines a plurality of axially-spaced recesses thereon formed by the serrations on the opposite side of the blade, and a plurality of discrete cutting tips formed between the recesses, that contribute to reducing the cutting forces and otherwise facilitating the ability to cut through work pieces. However, as may be recognized by those of ordinary skill in the pertinent art based on the teachings herein, the serrated blades may take any of numerous different configurations, including serrated configurations, that are currently known, or that later become known, including serrations formed on both or opposite sides of the blade, serrations defining different shapes and/or configurations than that shown, and/or different serrations on different sides of the blade or on different portions of the blade.

As illustrated in FIG. 1. the handle 14 includes a grip 56 at one end and a jaw defining a hollow recess 58 at the opposing end for supporting the pipe to be cut. The hollow recess 58 includes a slot 60 therein for receiving at least a portion of the blade 18 when the handles 12 and 14 are squeezed together and in the second position. In the illustrated embodiment, the hollow recess 58 defines a radius R2. R2 is within the range of about 1.31 inch to about 1.41 inches, and preferably is about 1.315 inches.

As shown in FIG. 1, the pipe cutter 10 further includes a locking mechanism 62. The locking mechanism 62 includes a manually engageable locking member 64 that is slidably mounted on the handle 14 and movable thereon between locked and unlocked positions, and a locking recess 66 formed on the other handle 16 for receiving therein the locking member 64 when the handles are in the closed position (not shown) for releasably locking the handles in that position. The handle 14 defines an axially-elongated recess 68 that slidably receives therein the locking member 64. As can be seen in FIG. 1, the locking member 64 is manually engageable and movable between an unlocked position, as shown, wherein the locking member 64 is moved forwardly within the recess 68, and an unlocked position (not shown) wherein the locking member is moved rearwardly within the recess 68. A retaining member 70 defining a forwardly projecting lip 72 is formed on the handle 16 at the rearward end of the locking recess 66 for retaining the locking member 64 and thus the handles 14, 16 in the locked position.

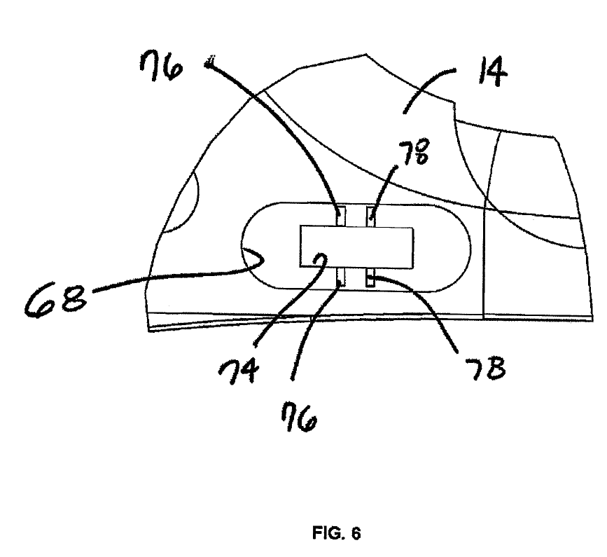

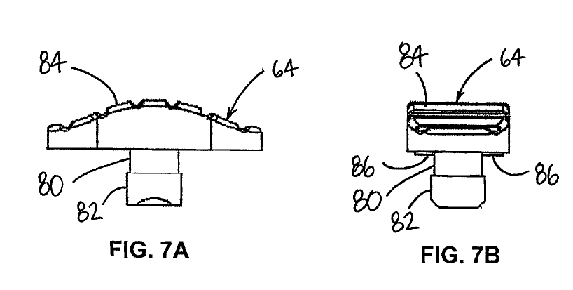

As shown in FIG. 6, the axially-elongated recess 68 of the handle 14 defines an axially-elongated aperture 74 formed through the handle, and two pairs of laterally-extending protuberances 76, 76 and 78, 78, wherein each pair of protuberances 76, 76 and 78, 78 is formed on opposite sides of the aperture 74 relative to each other, and the two pairs are axially spaced relative to each other about the midpoint of the aperture 74. As shown in FIGS. 7A and 7B, the locking member 64 includes a depending shaft 80, an expanded-diameter portion 82 formed on the free end of the shaft, a manually engageable button 84, and a pair of laterally-extending protuberances 86 that project downwardly from the underside of the button 84. The depending shaft 80 is slidably received within the axially-elongated aperture 74 with the expanded diameter portion 82 at the free end of the shaft located on the opposite side of the axially-elongated aperture 74 relative to the button 84 to retain the locking mechanism within the axially-elongated aperture. The pair of protuberances 86, 86 of the locking mechanism 64 form an interference fit with the axially spaced pairs of protuberances 76, 76 and 78, 78 of the handle 14 such that opposing pairs of protuberances frictionally engage one another when manually moving the locking member between the unlocked and locked positions to releasably retain the locking member in each such position. Accordingly, in the unlocked position, the first pair of protuberances 76, 76 frictionally engage the locking member protuberances 86, 86 and releasably retain the locking member in the unlocked position. Similarly, in the locked position, the second pair of protuberances 78, 78 frictionally engage the locking member protuberances 86, 86 and releasably retain the locking member in the locked position.

In the operation of the serrated pipe cutter 10, the pipe is placed within the hollow recess 58 of the jaw. The user manually engages the grips 56 and 16 and squeezes the handles 12 and 14 together. This action brings the tips of the blade 18 into initial contact with the pipe. The handles 12 and 14 are further squeezed together to drive the blade 18 into the pipe. The serrations 32 ease the frictional force between the pipe and the blade as the blade passes through the pipe. The blade passes through the pipe and at least a portion of the blade is received within the slot 60 in the second position to ensure a clean cut. When the grips 16 and 56 have been squeezed together, and the handles 12 and 14 are subsequently in a closed position, the locking mechanism 62 may be engaged to retain the handles in the closed position, for example, for safety or storage purposes.

As will be recognized by those skilled in the pertinent art based on the teachings herein, numerous changes and modifications may be made to the above-described and other embodiments of the present invention without departing from its scope as defined in the appended claims. For example, the handles, locking mechanism, and blade may be made of any of numerous different materials, or combinations of materials, that are currently known, or that later become known for performing their functions and/or depending on the application. In addition, the features of the serrated pipe cutter disclosed herein, and of the serrated blade, may be employed by other types of cutting tools or implements for cutting articles other than pipes. The handles can take numerous configurations; for example, the handles can be movable relative to one other, other than pivotally, as shown, in any way that is known or becomes known, such as by one or more linkages. The blade serrations and cutting tips can take on any of numerous shapes and/or configurations; for example, the cutting edge can include adjacent serrations without intervening cutting tips and/or adjacent tips without intervening serrations. Likewise, the hollow recess for supporting the article to be cut can take on any of numerous different shapes and/or configurations. Accordingly, this detailed description of preferred embodiments is to be taken in an illustrative, as opposed to a limiting sense.

1. A serrated pipe cutter comprising:
a first handle;
a serrated blade mounted on the first handle, wherein the blade defines a back edge, an elongated cutting edge located on an opposite side of the blade relative to the back edge, a first side edge extending between the back and cutting edges of the blade, a second side edge located on an opposite side of the blade relative to the first side edge, a blade body extending between the first, second, back and cutting edges of the blade, and at least one faceted surface tapering inwardly in a direction from the body toward the cutting edge of the blade;
wherein the elongated cutting edge defines a plurality of serrations axially spaced relative to each other along the cutting edge, wherein each serration defines a curvilinear serration boundary between the respective serration and the contiguous faceted surface, a substantially concave serration surface located within the curvilinear serration boundary and tapering inwardly in a direction from the body toward the cutting edge, and an axially-extending serration cutting edge, and wherein the elongated cutting edge of the blade further defines a plurality of cutting tips extending between adjacent serrations, wherein each cutting tip defines an axially extending cutting tip edge, and each serration cutting edge is recessed inwardly on the elongated cutting edge relative to at least one contiguous cutting tip edge; and
a second handle coupled to the first handle and defining a substantially concave recess for receiving therein a pipe to be cut, wherein at least one of the first and second handles is movable relative to the other to engage a pipe with the elongated cutting edge of the blade and cut the pipe.

2. A serrated pipe cutter as defined in claim 1, wherein a plurality of the serrated cutting edges each define a plurality of substantially linear cutting edge surfaces, wherein at least one linear cutting edge surface is angled inwardly toward the body at an acute angle within the range of about 8° to about 12°.

3. A serrated pipe cutter as defined in claim 2, wherein each of said serrated cutting edges defines two substantially linear cutting edge surfaces located on opposite sides of the serrated cutting edge relative to each other and angled inwardly toward the body, and at least one substantially linear cutting edge extending between the two angled cutting edges.

4. A serrated pipe cutter as defined in claim 1, wherein a plurality of the cutting tips each define a substantially straight axially extending cutting tip edge, and a pair of faceted surfaces on opposite sides of the cutting tip relative to each other and tapering inwardly toward the axially extending cutting tip edge.

5. A serrated pipe cutter as defined in claim 4, wherein the faceted surfaces of each cutting tip taper inwardly relative to the respective side of the blade body at an angle within the range of about 20° to about 30°.

6. A serrated pipe cutter as defined in claim 1, wherein a plurality of the serration cutting edges each define an axial length within the range of about 4/100 inch and about 9/100 inch, and a plurality of the cutting tip edges each define an axial length within the range of about 3/100 inch and about 8/100 inch.

7. A serrated pipe cutter as defined in claim 1, wherein a plurality of the serration boundaries each define an apex, and a pair of substantially symmetrical, curvilinear boundary lines, each extending on opposite sides of the apex relative to each other between the apex and a respective contiguous cutting tip.

8. A serrated pipe cutter as defined in claim 7, wherein each serration boundary is substantially elliptical shaped.

9. A serrated pipe cutter as defined in claim 1, wherein a plurality of the cutting tips each define a first substantially linear cutting tip boundary between the respective cutting tip and a contiguous faceted surface, a second substantially linear cutting tip boundary between the cutting tip and an adjacent serration, a third substantially linear cutting tip boundary between the cutting tip and an adjacent serration opposite the second cutting tip boundary, and faceted surfaces formed on opposites sides of the cutting tip relative to each other within the first and second boundaries and tapering inwardly in the direction from the body toward the cutting edge.

10. A serrated pipe cutter as defined in claim 1, wherein at least a portion of each serration cutting edge is at least one of (i) substantially curvilinear and (ii) substantially straight.

11. A serrated pipe cutter as defined in claim 10, wherein at least a portion of each cutting tip edge is at least one of (i) substantially curvilinear and (ii) substantially straight.

12. A serrated pipe cutter as defined in claim 1, wherein each cutting tip defines faceted surfaces on opposite sides of the cutting tip relative to each other that taper inwardly toward the respective cutting tip edge, and each faceted surface is least one of (i) substantially concave and (ii) substantially planar.

13. A serrated pipe cutter as defined in claim 1, wherein the serrations are substantially equally spaced relative to each other along the elongated cutting edge.

14. A serrated pipe cutter as defined in claim 11, wherein each serration defines an apex, and the distance between each serration apex and contiguous cutting tip edge is within the range of about 3/100 inch to about 9/100 inch.

15. A serrated pipe cutter as defined in claim 1, wherein each substantially concave serration surface is defined by a radius within the range of about 2 inches to about 4 inches.

16. A serrated pipe cutter as defined in claim 1, wherein the faceted surface tapers inwardly at an angle within the range of about 8° to about 12°.

17. A serrated cutter as defined in claim 1, wherein the plurality of serrations are located on one side of the cutting edge, and the blade defines a substantially planar surface on an opposite side of the blade relative to the serrations, and a plurality of axially-spaced, recessed surfaces formed on an opposite side of the cutting edge relative to the serrations, wherein each recessed surface is defined by a respective serration.

18. A serrated pipe cutter as defined in claim 1, further comprising a locking mechanism mounted on one of the first and second handles and movable between a locked position and an unlocked position, wherein in the locked position the locking mechanism engages at least one of the first and second handles to prevent movement of at least one of the handles relative to the other when the handles are in a closed position, and in the unlocked position, wherein the locking mechanism is disengaged from at least one of the first and second handles to allow movement of at least one of the handles relative to the other from a closed position to an open position.

19. A serrated pipe cutter as defined in claim 18, wherein the locking mechanism further comprises a manually engageable actuator movable between the locked and the unlocked positions, at least one actuator protuberance formed on the actuator, and at least two axially spaced handle protuberances formed on one of the first and second handles, wherein in the locked position the actuator protuberance frictionally engages a first handle protuberance to releasably retain the locking member in the locked position, and in the unlocked position, the actuator protuberance frictionally engages a second handle protuberance to releasably retain the locking member in the unlocked position.

20. A serrated pipe cutter comprising:
first means for manually gripping;
second means mounted on the first means for cutting a pipe, wherein the second means defines an axially elongated cutting edge including a plurality of third means for serrating the cutting edge that are axially spaced relative to each other along the cutting edge, and a plurality of fourth means for forming non-serrated cutting edge segments that are axially spaced relative to each other along the cutting edge, wherein each of a plurality of fourth means are located between respective third means, and the third means are recessed inwardly on the elongated cutting edge relative to adjacent fourth means; and
fifth means coupled to the first means for supporting the pipe and for manually gripping, wherein at least one of the first and fifth means is manually movable relative to the other for driving the elongated cutting edge of the second means into engagement with the pipe to cut the pipe.

21. A serrated pipe cutter as defined in claim 20, further comprising sixth means coupled to at least one of the first means and fifth means for releasably engaging at least one of the first means and the fifth means and preventing relative movement thereof.

22. A serrated pipe cutter as defined in claim 20, wherein the first means is a first handle; the second means is a blade; each third means is a serration axially spaced relative to an adjacent serration, wherein each serration defines a boundary having an apex and curvilinear boundary lines extending substantially symmetrically between the apex and the cutting edge, a substantially concave serration surface formed within the boundary, and a serration cutting edge; each fourth means is a cutting tip defining a substantially linear cutting edge segment and a pair of faceted surfaces formed on opposite sides of the cutting tip relative to each other and tapering inwardly toward the respective linear cutting edge, wherein each serration cutting edge is recessed inwardly relative to at least one contiguous linear cutting edge segment, and the fifth means is a second handle.

23. A serrated blade defining an elongated serrated cutting edge and mountable within a serrated pipe cutter including a first handle, a second handle coupled to the first handle and defining a substantially concave recess for receiving therein a pipe to be cut, wherein at least one of the first and second handles is movable relative to the other to engage a pipe with the elongated cutting edge of the blade and cut the pipe, wherein the serrated blade defines a back edge, an elongated cutting edge located on an opposite side of the blade relative to the back edge, a first side edge extending between the back and cutting edges of the blade, a second side edge located on an opposite side of the blade relative to the first side edge, a blade body extending between the first, second, back and cutting edges of the blade, and a faceted surface tapering inwardly in a direction from the body toward the cutting edge of the blade, and wherein the elongated cutting edge defines a plurality of serrations axially spaced relative to each other along the cutting edge, and each serration defines a curvilinear serration boundary between the respective serration and the contiguous faceted surface, a substantially concave serration surface located within the curvilinear serration boundary and tapering inwardly in a direction from the body toward the cutting edge, and an axially-extending serration cutting edge, and wherein the elongated cutting edge of the blade further defines a plurality of cutting tips extending between adjacent serrations, each cutting tip defines an axially extending cutting tip edge, and each serration cutting edge is recessed inwardly on the elongated cutting edge relative to at least one contiguous cutting tip edge.
